(19) United States
(12) Patent Application Publication
(10) Pub. No.: US 2014/0143021 A1
(43) Pub. Date: May 22, 2014

(54) DETERMINING A PRICE

(71) Applicant: REVD, INC, Mountain View, CA (US)

(72) Inventor: Wycliffe D. Niles, San Jose, CA (US)

(73) Assignee: Revd, Inc, Mountain View, CA (US)

(21) Appl. No.: 13/683,570

(22) Filed: Nov. 21, 2012

(51) Int. Cl. G06Q 30/02

(52) U.S. Cl. CPC G06Q 30/0206
USPC 705/7.35

(57) ABSTRACT

A machine may be configured to generate a user interface that proposes an event to be scheduled in the future and solicits attendee bids, venue offers, sponsorship offers, or any suitable combination thereof. In some situations, the event includes one or more appearances by talent. The machine may be configured to receive the attendee bids from potential purchasers, venue offers from venue providers, sponsorship offers from potential sponsors, or any suitable combination thereof, via the user interface. The machine may identify a portion of the potential purchasers as winning bidders on tickets for the event, based on an attendee capacity supported by a venue, based on a portion of the attendee bids specifying higher prices per attendee than a remainder of the attendee bids, or based on both. The machine may assign a common price per attendee to each of the portion of the potential purchasers.

### TECHNICAL FIELD

The subject matter disclosed herein generally relates to the processing of data. Specifically, the present disclosure addresses systems and methods to facilitate determining a price.

### BACKGROUND

A network-based system may be used to advertise and sell tickets to an event scheduled to occur in the future (e.g., a concert, a play, a sports event, or other event for which tickets are sold). In merchandising one or more tickets for a scheduled event, a seller may use the network-based system to present a document (e.g., a webpage) that describes the event links to an electronic marketplace from which the one or more tickets may be purchased by a user of the network-based system (e.g., a potential purchaser of tickets). Examples of network-based systems include commerce systems (e.g., shopping websites or auction websites), publication systems (e.g., classified advertisement websites), listing systems (e.g., wish list websites or gift registries), transaction systems (e.g., payment websites), and social network systems (e.g., Facebook®, Twitter®, or LinkedIn®).

### BRIEF DESCRIPTION OF THE DRAWINGS

Some embodiments are illustrated by way of example and not limitation in the figures of the accompanying drawings.

FIG. 1 is a network diagram illustrating a network environment suitable for determining a price, according to some example embodiments.

FIG. 2 is a block diagram illustrating components of an event management machine suitable for determining a price, according to some example embodiments.

FIG. 3-9 are flowcharts illustrating operations of the event management machine in performing a method of price determination, according to some example embodiments.

FIG. 10 is a block diagram illustrating components of a machine, according to some example embodiments, able to read instructions from a machine-readable medium and perform any one or more of the methodologies discussed herein, in whole or in part.

### DETAILED DESCRIPTION

Example methods and systems are directed to determination of a price (e.g., price determination or determining a price). Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

A machine may be configured (e.g., by software modules) as an event management machine that forms all or part of a network-based system. The machine may be configured to generate a user interface (e.g., within a webpage or website) that proposes an event to be scheduled in the future and solicits attendee bids, venue offers, sponsorship offers, or any suitable combination thereof, for the proposed event. In many situations, the event includes one or more appearances (e.g., performances) by talent (e.g., a performer). The machine may be configured to receive the attendee bids from potential purchasers of tickets to the event, venue offers from venue providers, sponsorship offers from potential sponsors, or any suitable combination thereof, via the user interface. The machine may accordingly identify a portion of the potential purchasers as winning bidders on tickets (e.g., winning or successful attendee bidders who bid on tickets to the event). This identification of the winning bidders may be based on an attendee capacity supportable by a venue (e.g., a maximum seating capacity of a venue selected by the talent, or a portion thereof, as specified by the talent), based on a portion of the attendee bids specifying higher prices per attendee than a remainder of the attendee bids, or based on both.

The machine may then assign a common price per attendee to each of the portion of the potential purchasers (e.g., a common price per attendee shared among all of the winning bidders on tickets), and this common price per attendee may be specified in an attendee bid received from a potential purchaser outside of the identified portion of the potential purchasers (e.g., an attendee bid received from a non-winning bidder). For example, the highest non-winning attendee bid may specify the price per attendee, so that all winning bidders can purchase tickets to the event at prices below the maximum that they are willing to pay. After determining the price per attendee for the event, the machine may schedule the event (e.g., at the venue selected by the talent, with a sponsor selected by the talent). Further details are described below.

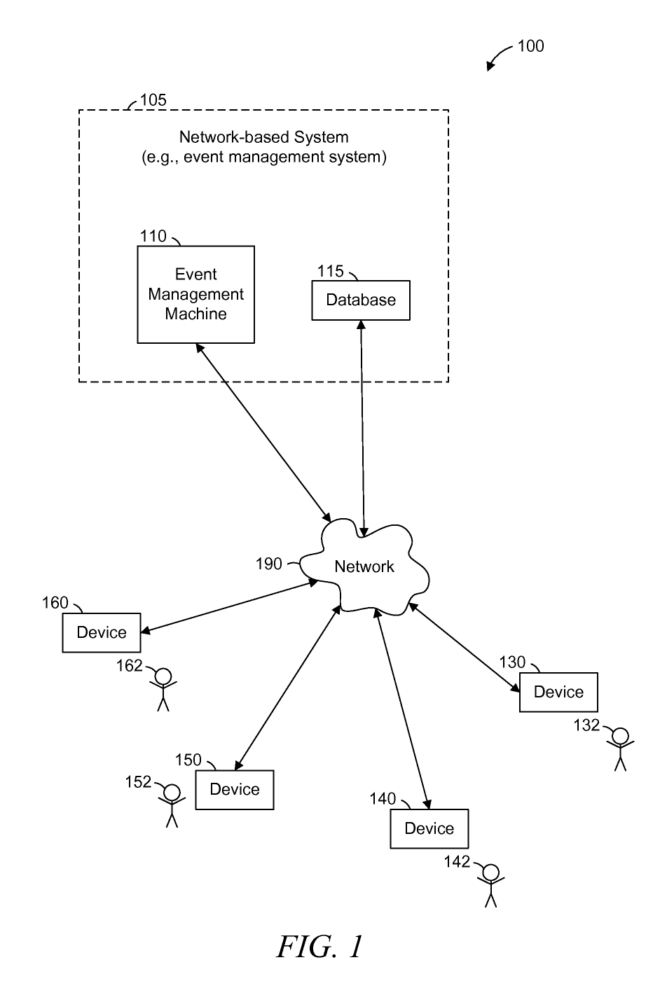

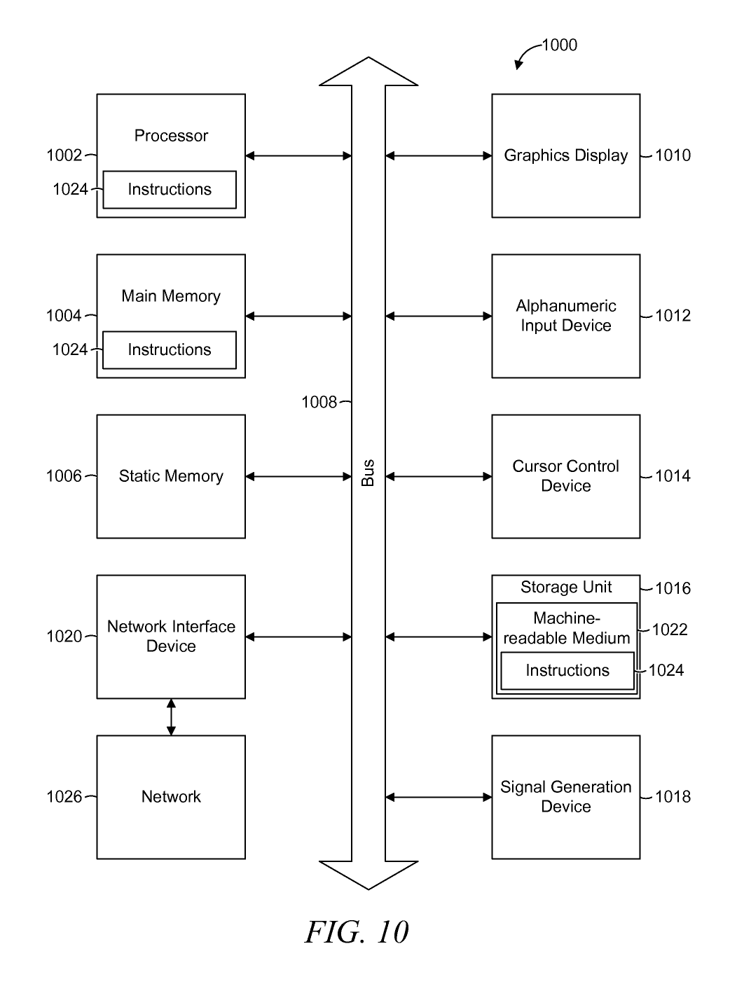

FIG. 1 is a network diagram illustrating a network environment 100 suitable for determining a price, according to some example embodiments. The network environment 100 includes an event management machine 110, a database 115, and devices 130, 140, 150, and 160, all communicatively coupled to each other via a network 190. The event management machine 110, the database 115, and the devices 130, 140, 150, and 160 may each be implemented in a computer system, in whole or in part, as described below with respect to FIG. 10.

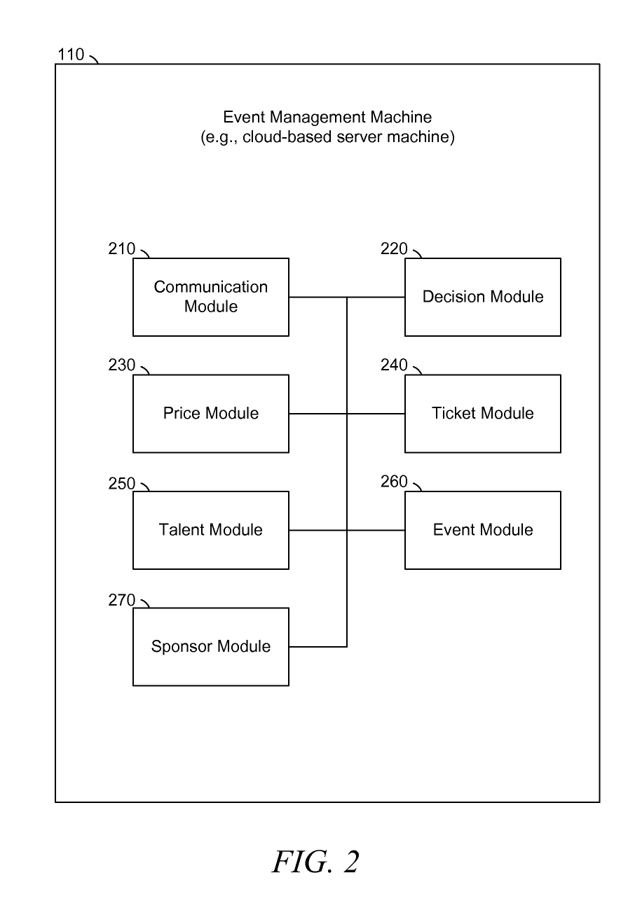

The event management machine 110 may be configured (e.g., by software modules described below with respect to FIG. 2) to perform any one or more of the various methodologies described herein, in whole, or in part. The event management machine 110, with or without the database 115, may form all or part of a network-based system 105. The network-based system 105 may be an event management system that provides one or more event management services (e.g., proposing events, soliciting bids for an event, soliciting venue offers for the event, soliciting sponsorship offers for the event, determining a price per attendee to attend the event, providing tickets for the event, scheduling the event, or any suitable combination thereof).

Also shown in FIG. 1 are users 132, 142, 152, and 162. One or more of the users 132, 142, 152, and 162 may be a human user (e.g., a human being), a machine user (e.g., a computer configured by a software program to interact with the device 130), or any suitable combination thereof (e.g., a human assisted by a machine or a machine supervised by a human). The user 132 is not part of the network environment 100, but is associated with the device 130 and may be a user of the device 130. For example, the device 130 may be a desktop computer, a vehicle computer, a tablet computer, a navigational device, a portable media device, or a smart phone belonging to the user 132. Likewise, the user 142 is not part of the network environment 100, but is associated with the device 140. As an example, the device 140 may be a desktop computer, a vehicle computer, a tablet computer, a navigational device, a portable media device, or a smart phone belonging to the user 142. Similarly, the user 152 is not part of the network environment 100, but is associated with the device 150. As an example, the device 150 may be a desktop computer, a vehicle computer, a tablet computer, a navigational device, a portable media device, or a smart phone belonging to the user 152. Likewise, the user 162 is not part of the network environment 100, but is associated with the device 160. As an example, the device 160 may be a desktop computer, a vehicle computer, a tablet computer, a navigational device, a portable media device, or a smart phone belonging to the user 162.

Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIG. 10. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 190 may be any network that enables communication between or among machines, databases, and devices (e.g., the event management machine 110 and the devices 130, 140, and 160). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof.

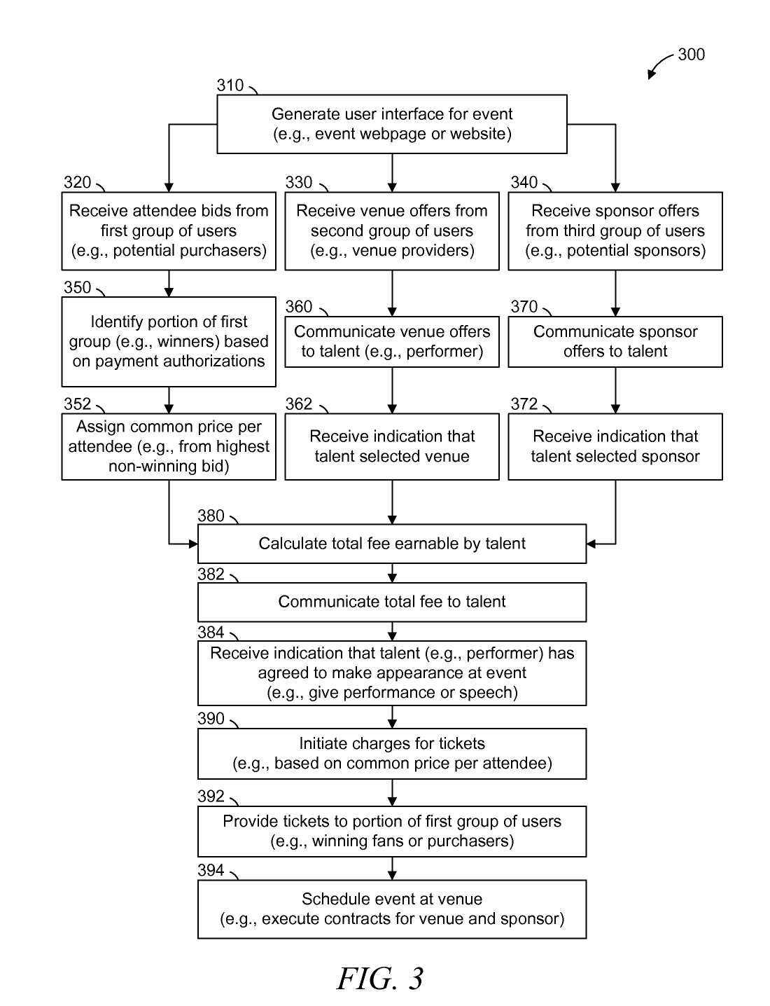

FIG. 2 is a block diagram illustrating components of the event management machine 110, according to some example embodiments. The event management machine 110 is shown as including a communication module 210, a decision module 220, a price module 230, a ticket module 240, a talent module 250, an event module 260, and a sponsor module 270, all configured to communicate with each other (e.g., via a bus, shared memory, or a switch). Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices. The functions of various modules of the event management machine 110 are discussed below with respect to FIG. 3-9.

FIG. 3-9 are flowcharts illustrating operations of the event management machine 110 in performing a method 300 of price determination (e.g., determining a price), according to some example embodiments. Operations in the method 380 performed by the event management machine 110, using modules described above with respect to FIG. 2. As shown in FIG. 3, some example embodiments of the method 300 begin with operation 310. In operation 310, the communication module 210 generates a user interface (e.g., a graphical user interface within an interactive webpage, document, application, applet, or app) that proposes an event (e.g., a concert, a stage production, a play, a comedy show, a sports event, a screening of a movie, a magic show, a “one man” show, a fan “meet and greet,” a book signing, a press release, a public relations event, or any suitable combination thereof). The user interface may also solicit attendee bids for tickets to the event, venue offers to host the event, sponsorship offers to sponsor the event, or any suitable combination thereof. In some example embodiments, operation 310 includes generating a website or webpage for the event (e.g., an event webpage or website for official news and information on the event and its scheduling details, such as date, venue, talent, sponsorship, and purchase of tickets).

In operation 320, the communication module 210 receives attendee bids (e.g., a group or plurality of attendee bids) via the user interface generated in operation 310. The attendee bids may be received from potential purchasers (e.g., fans of the talent, bidders on tickets, or both) of tickets for the event, and these potential purchasers may constitute a first group of users (e.g., viewers) of the user interface. As used herein, an “attendee bid” is an offer to purchase one or more tickets to attend the event. An attendee bid may specify (e.g., by inclusion) a price per attendee (e.g., a price per ticket). At least some of the attendee bids may differ in price per attendee to attend the event. That is, the received attendee bids may be diverse in their respective prices per attendee.

In operation 330, the communication module 210 receives venue offers (e.g., a group or plurality of venue offers) via the user interface generated in operation 310. The venue offers may be received from venue providers (e.g., venue managers or booking agents), and these venue providers may constitute a second group of users (e.g., viewers) of the user interface. As used herein, a “venue offer” is an offer to host (e.g., produce) the event, in whole or in part, at a venue (e.g., a concert hall, an auditorium, a theater, a sports stadium, an amphitheater, an arena, a ballpark, a television studio, a public park, a private home, an Internet broadcasting channel, or any suitable combination thereof). A venue offer may specify (e.g., by inclusion of a name of, or reference to) a corresponding venue, and the specified venue may have an attendance capacity, which may be specified in the venue offer. Additionally, a venue offer may specify (e.g., by inclusion) a cost of the venue (e.g., venue cost), a payment offered by the venue (e.g., to the talent for performing at the event), or both. In some cases, a venue offer may be a no-cost offer by the venue to host the event for free. At least some of venue offers may differ in their respective costs, payments offered, or any suitable combination thereof. That is, the venue offers may be diverse in their venue costs and payments offered.

In operation 340, the communication module 210 receives sponsor offers (e.g., a group or plurality of sponsor offers) via the user interface generated in operation 310. The sponsor offers may be received from potential sponsors (e.g., prospective advertisers or merchandisers of a product or service) for the event, and these potential sponsors may constitute a third group of users (e.g., viewers) of the user interface. As used herein, a “sponsor offer” is an offer to sponsor the event, in whole or in part. A sponsor offer may specify (e.g., by inclusion of a name of, or reference to) a potential sponsor for the event. Additionally, a sponsor offer may specify (e.g., by inclusion) a payment offered by the sponsor (e.g., to the talent for selecting the potential sponsor). At least some of the sponsor offers may differ in their respective payments offered. That is, the sponsor offers may be diverse in their payments offered.

In operation 350, which may follow operation 320, the decision module 220 identifies a portion of the potential purchasers from the attendee bids that were received in operation 320. In particular, the decision module 220 may identify the portion of the potential purchasers as winning bidders (e.g., who will purchase tickets to attend the event as attendees of the event, if the event is scheduled). Operation 350 may be performed based on an attendee capacity supported by a venue (e.g., a venue selected by the talent). For example, the attendee capacity may be the maximum attendee capacity of a venue selected by the talent that will appear (e.g., perform) at the event. As another example, the attendee capacity may be a portion of the maximum capacity of the venue (e.g., fewer tickets to be sold than the actual maximum capacity of the venue, for a more intimate or exclusive event), and such a portion may be specified by the talent (e.g., in selecting the venue). Operation 350 may be performed based on a portion of the attendee bids (e.g., submitted by the portion of the potential purchasers) specifying higher prices per attendee (e.g., higher ticket prices) then the remainder of the attendee bids (e.g., submitted by the remainder of the potential purchasers). In some example embodiments, operation 350 may be performed based on the attendee capacity and the portion of the attendee bids specifying higher prices per attendee than the remainder of the attendee bids.

In operation 360, which may follow operation 330, the talent module 250 communicates some or all of the venue offers received in operation 330. Some or all of the venue offers may be communicated to talent (e.g., a performer) that is proposed to perform at the event. For example, the talent module 250 may update the user interface generated in operation 310 (e.g., a private portion of the user interface that is accessible only by the talent) to indicate the communicated venue offers. As another example, the talent module 250 may send an email or text message that conveys the communicated venue offers to the talent. As used herein, “talent” refers to an entity (e.g., one or more performers or celebrities or groups thereof) proposed to make an appearance at the event (e.g., give a performance or a speech, or otherwise participate in producing the event). An appearance at the event may be physical (e.g., live physical presence) or virtual (e.g., via video conference). Examples of talent include a sports team, a rock band, a theater company, a chef, a musician, a singer, a poet, a writer, an actor, a dancer, a politician, a scientist, a historian, a motivational speaker, a lecturer, a clergyperson, a professor, a journalist, and any suitable combination thereof. Hence, the talent may select a venue to host the event, based on the communicated venue offers.

In operation 370, which may follow operation 340, the sponsor module 270 communicates some or all of the sponsor offers received in operation 340. Some or all of the sponsor offers may be communicated to the talent (e.g., performer) that is proposed to make an appearance at the event. For example, the sponsor module 270 may update the user interface generated in operation 310 (e.g., a private portion of the user interface that is accessible only by the talent) to indicate the communicated sponsor offers. As another example, the sponsor module 270 may send an email or text message that conveys the communicated sponsor offers to the talent. The talent may select a sponsor (e.g., one or more sponsors) to sponsor the event, based on the communicated sponsor offers.

In operation 352, which may follow operation 350, the price module 230 assigns a common price per attendee (e.g., a single price per attendee that is shared in common) to each potential purchaser in the portion of the potential purchasers identified in operation 350 (e.g., to each winning bidder who will purchase one or more tickets to the event, if the event is scheduled). That is, all of the winning bidders may be assigned a single price per attendee (e.g., price per ticket or price per seat) that is shared in common by the winning bidders. In some example embodiments, the common price per attendee may be specified in one of the attendee bids received in operation 320. In certain example embodiments, the common price per attendee may be specified in an attendee bid that is received from a potential purchaser outside of the identified portion of the potential purchasers (e.g., received from a non-winning bidder). For example, the price module 230 may assign the price per attendee specified in the highest non-winning attendee bid as the common price per attendee for all of the winning bidders. As another example, the second-highest non-winning attendee bid may specify the price per attendee used as the common price per attendee for all winning bidders. In alternative example embodiments, the common price per attendee may be specified in an attendee bid that is received from a potential purchaser within the identified portion of the potential purchasers (e.g., received from a winning bidder). For example, the price module 230 may assign the price per attendee specified in the lowest winning attendee bid as the common price per attendee for all of the winning bidders.

In operation 362, which may follow operation 360, the talent module 250 receives an indication that the talent (e.g., performer) has selected a venue to host the event (e.g., based on the venue offers communicated in operation 360). For example, the talent module 250 may detect that the talent (e.g., via an agent or an administrative assistant) has selected the venue using (e.g., via) the user interface generated in operation 310. As another example, the talent module 250 may receive a message (e.g., an email or a text message) from the talent (e.g., via an agent or an administrative assistant) indicating that the talent has selected the venue to host the event. Hence, the event management machine 110 may allow the talent to choose the venue at which the event will take place.

In operation 372, which may follow operation 370, the sponsor module 270 receives an indication that the talent has selected a sponsor for the event (e.g., based on the sponsor offers communicated in operation 370). For example, the sponsor module 270 may detect that the talent (e.g., via an agent or secretary) has selected the sponsor using (e.g., via) the user interface generated in operation 310. As another example, the sponsor module 270 may receive a message (e.g., an email or a voicemail) from the talent (e.g., via an agent or a secretary) indicating that the talent has selected a sponsor for the event. Hence, the event management machine 110 may allow the talent to choose one or more sponsors to sponsor the event.

In operation 380, which may follow one or more of operations 352, 362, and 372, the talent module 250 calculates a total fee earnable by the talent for making an appearance (e.g., giving a performance or speech) at the event. The talent module 250 may calculate the total fee based on the attendee capacity for the selected venue (e.g., as specified in the corresponding venue offer, as specified by the talent, or both), the common price per attendee assigned in operation 352, the venue cost of the selected venue (e.g., as specified in the corresponding venue offer), a payment offered by the venue to the talent (e.g., as specified in the corresponding venue offer), one or more payments offered by one or more selected sponsors (e.g., as specified in the corresponding sponsor offers), or any suitable combination thereof.

In operation 382, which may follow operation 380, the talent module 250 communicates the total fee calculated in operation 380 to the talent. For example, the talent module 250 may update the user interface generated in operation 310 (e.g., a private portion of the user interface accessible only by the talent) to indicate the calculated total fee earnable by the talent. As another example, the talent module 250 may send the talent a message (e.g., an email or a text message) that conveys the total fee earnable by the talent.

In operation 384, which may follow operation 382, the talent module 250 receives an indication that the talent has agreed to make an appearance (e.g., give a performance or speech, or otherwise participate) at the event. For example, the talent module 250 may detect that the talent (e.g., via an agent or an administrative assistant has submitted the indication using (e.g., via) the user interface generated in operation 310. As another example, the talent module 250 may receive a message (e.g., an email or a text message) from the talent that conveys an agreement by the talent to make an appearance at the event.

In operation 390, which may follow operation 384, the ticket module 240 initiates charges for tickets to the event. For example, the ticket module 240 may initiate payment transactions for some or all of the portion of the potential purchasers identified in operation 350 (e.g., winning bidders for tickets). Operation 390 may be performed based on the common price per attendee assigned in operation 352 (e.g., as specified in an attendee bid received from a potential purchaser outside the identified portion of the potential purchasers). For example, the ticket module 240 may charge each member of the identified portion of the potential purchasers the price per attendee specified in the highest non-winning attendee bid. As another example, the price per attendee specified in the second-highest non-winning attendee bid may be used. As a further example, the price per attendee specified in the lowest winning attendee bid may be used. In some example embodiments, the charges (e.g., payment) are initiated all at once, while in other example embodiments, the charges may be initiated in a series of batches.

In operation 392, which may follow operation 390, the ticket module 240 provides tickets to the portion of the potential purchasers identified in operation 350 (e.g., to the winning bidders on tickets). The tickets may be provided based on the common price per attendee assigned in operation 352 (e.g., at the common price per attendee, with or without an additional service fee charged by the network-based system 105). As noted above, the assigned common price per attendee may be specified in an attendee bid received from a potential purchaser outside of the identified portion of the potential purchasers. The ticket module 240 may provide physical tickets (e.g., tickets printed on paper and sent by mail), virtual tickets (e.g., electronic tickets sent or referenced by electronic message), or any suitable combination thereof. In some example embodiments, the ticket module 240 provides a ticket by communicating a message that the ticket (e.g., physical or virtual) is available for subsequent pickup (e.g., at a “will call” window or office at the venue).

In operation 394, which may follow operation 392, the event module 260 schedules the event. The event may be scheduled at the venue selected by the talent (e.g., as indicated in operation 362). The event may be scheduled with sponsorship by one or more sponsors selected by the talent (e.g., as indicated in operation 372). Accordingly, operation 394 may be performed based on the indication received in operation 384 (e.g., the indication that the talent has agreed to a make an appearance at the event), the indication received in operation 362 (e.g., the indication that the talent has selected the venue), the indication received in operation 372 (e.g., the indication that the talent has selected a sponsor), or any suitable combination thereof. In some example embodiments, the event module 260 schedules the event by updating the user interface generated in operation 310 (e.g., with an indication that the event previously proposed is now scheduled or confirmed), updating a calendar of events at the selected venue, providing a contract to the venue provider that corresponds to the selected venue, providing a contract to one or more selected sponsors, or any suitable combination thereof.

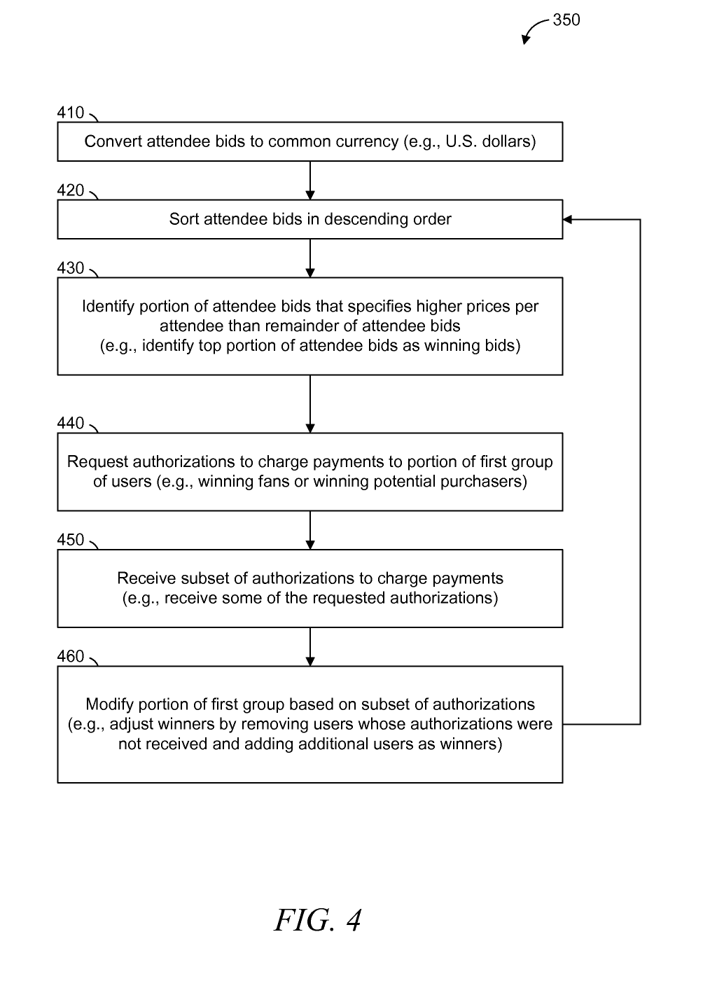

FIG. 4 illustrates further details of operation 350, in which the decision module 220 identifies the portion of the potential purchasers (e.g., the portion of the first group of users of the user interface generated in operation 310). As shown, operation 350 may include one or more of operations 410, 420, 430, 440, 450, and 460.

In operation 410, the decision module 220 converts the attendee bids received in operation 320 into a common currency (e.g., U.S. dollars). In operation 420, the decision module 220 sorts the attendee bids according to their respective values for price per attendee (e.g., price per ticket or price per seat). For example, the decision module 220 may generate a list that arranges the attendee bids in descending order (e.g., highest to lowest price per attendee).

In operation 430, the decision module 220 identifies a portion of the attendee bids that specify higher prices per attendee than a remainder of the attendee bids. For example, the decision module 220 may identify the top (e.g., highest value) portion of the attendee bids. The identified portion of the attendee bids may be identified as winning bids. The decision module 220 may identify the portion based on the attendance capacity of the venue to host the event (e.g., as selected by the talent). For example, if there are 1000 attendee bids received in operation 320 and sorted (e.g., ranked) in operation 420, and the attendance capacity of the venue is 200 seats, the decision module 220 may identify the top 200 attendee bids as winning attendee bids and identify the bottom 800 attendee bids as losing attendee bids. Identification of the portion of the attendee bids may result in identification of a portion of the potential purchasers that correspond to the identified portion of the attendee bids. Accordingly, operation 430 may result in identification of a portion of the potential purchasers as winning bidders.

In operation 440, the decision module 220 requests (e.g., initiates) authorizations to charge payments to those potential purchasers (e.g., a portion of the potential purchasers) that submitted the portion of the attendee bids identified in operation 430. For example, the decision module 220 may request authorizations to charge financial accounts (e.g., credit card accounts, bank accounts, or other stored value accounts) of some or all of those potential purchasers (e.g., the winning bidders for tickets). Operation 440 may be performed based on a price per attendee specified in an attendee bid outside of the identified portion of the attendee bids. For example, the price per attendee may be specified in the highest non-winning attendee bid. As another example, the price per attendee may be specified in the second-highest non-winning attendee bid. In alternative example embodiments, operation 440 may be performed based on a price per attendee specified in an attendee bid within the identified portion of the attendee bids. For example, the price per attendee specified in the lowest winning attendee bid may be used. In some example embodiments, the authorizations (e.g., uncommitted payment transactions) are requested all at once, while in other example embodiments, the authorizations may be requested in a series of batches.

In operation 450, the decision module 220 receives a subset of the authorizations requested in operation 440. For example, out of 200 authorizations requested, the decision module 220 may receive 180 authorizations in response, with the remaining 20 requests failing to return authorizations (e.g., due to authorization being denied, communication errors, timeouts, or other problems). In some situations, the received subset contains all of the authorizations requested in operation 440. In other situations, the received subset contains a portion of the authorizations requested in operation 440.

In operation 460, the decision module 220 modifies (e.g., updates, revises, or adjusts) the portion of the potential purchasers identified in operation 430 (e.g., identified by their corresponding attendee bids). The modification of the portion may be based on the subset of the authorizations (e.g., as received in operation 450). For example, if the decision module 220 received 180 out of 200 authorizations requested, the decision module 220 may add an additional 20 attendee bids (e.g., the top 20 non-winning attendee bids) to the portion of the attendee bids (e.g., as previously identified in operation 430), thus modifying the portion of the attendee bids. This may have the effect of adjusting the winning bidders by removing those potential purchasers whose authorizations were not received and by adding additional potential purchasers as winning bidders. As shown in FIG. 4, one or more of operations 420, 430, 440, 450, and 460 may be repeated (e.g., until authorizations have been received for all winning bidders). According to various example embodiments, when authorizations to charge payments to each of the identified portion of potential purchasers have been received, modification of the identified portion ceases, and identification of the portion is treated as being complete. In example embodiments that include operation 460, operation 390 may be performed based on the modified portion of the prospective purchasers.

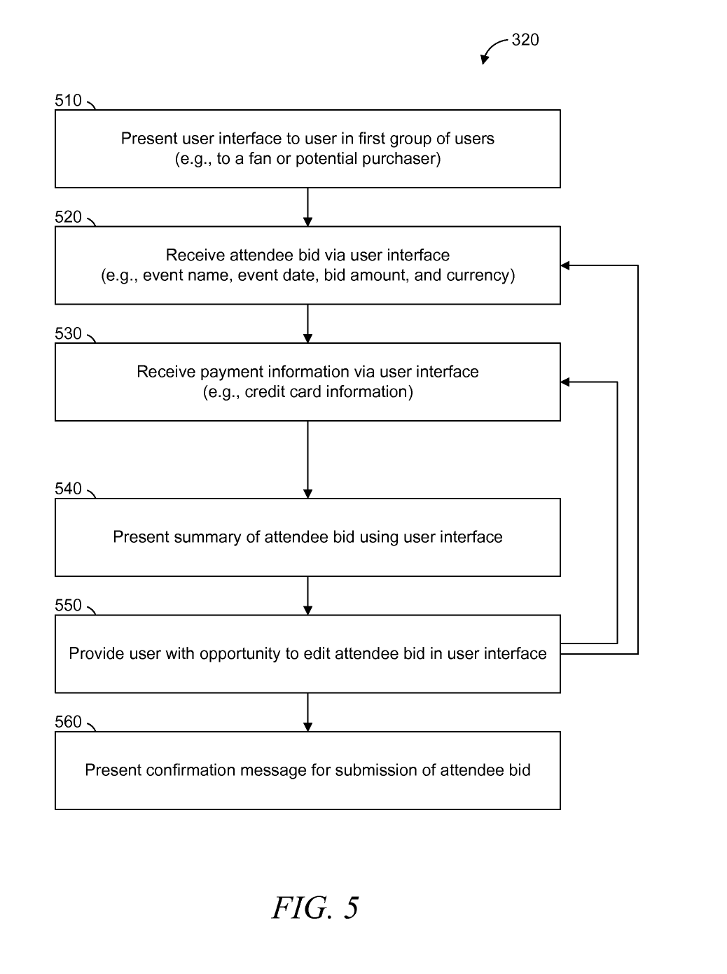

FIG. 5 illustrates further details of operation 320, in which the communication module 210 receives the attendee bids from the potential purchasers (e.g., the first group of users of the user interface generated in operation 310). As shown, operation 320 may include one or more of operations 510, 520, 530, 540, 550, and 560.

In operation 510, the communication module 210 presents the user interface (e.g., as generated in operation 310) to a user of the user interface (e.g., to a potential purchaser of a ticket to the event). In some example embodiments, the user is presented with a private portion of the user interface (e.g., accessible only to the user, for example, by submitting a username and password).

In operation 520, the communication module 210 receives an attendee bid via the user interface (e.g., generated in operation 310). The attendee bid may be submitted by the user to whom the user interface is presented in operation 510. According to various example embodiments, the attendee bid may specify (e.g., by inclusion or reference) a name of the event (e.g., an event name), a date of event (e.g., an event date), a bid amount (e.g., a bid for price per attendee, with or without a number of attendees, seats, or tickets proposed to be purchased at the bid price per attendee), a currency (e.g., U.S. dollars or Euros), or any suitable combination thereof.

In operation 530, the communication module 210 receives payment information that corresponds to the attendee bid received in operation 520. Examples of such payment information include credit card number, bank account number, or other information suitable for initiating a payment transaction or an authorization thereof. The payment information may be received by the user interface (e.g., generated in operation 310), and the payment information may correspond to the user that submitted the attendee bid.

In operation 540, the communication module 210 presents (e.g., via the user interface generated in operation 310) a summary of the attendee bid received in operation 520. The summary of the attendee bid may include some or all of the payment information received in operation 530.

In operation 550, the communication module 210 provides the user with an opportunity to edit some or all of the information presented in the summary of the attendee bid. For example, the communication module 210 may present (e.g., via the user interface generated in operation 310) a confirmation screen or dialog box that prompts the user to confirm or edit the attendee bid (e.g., as summarized in operation 540). As shown in FIG. 5, one or more of operations 520, 530, 540, and 550 may be repeated (e.g., until the user is finished submitting or editing the attendee bid, the payment information, or any suitable combination or portion thereof).

In operation 560, the communication module 210 presents the user with a confirmation message (e.g., via the user interface generated in operation 310, or via email or text message) that the user's attendee bid has been submitted. According to various example embodiments, operations 510-560 may be repeated for each potential purchaser (e.g., bidder) of tickets for the event (e.g., as proposed by the user interface generated in operation 310).

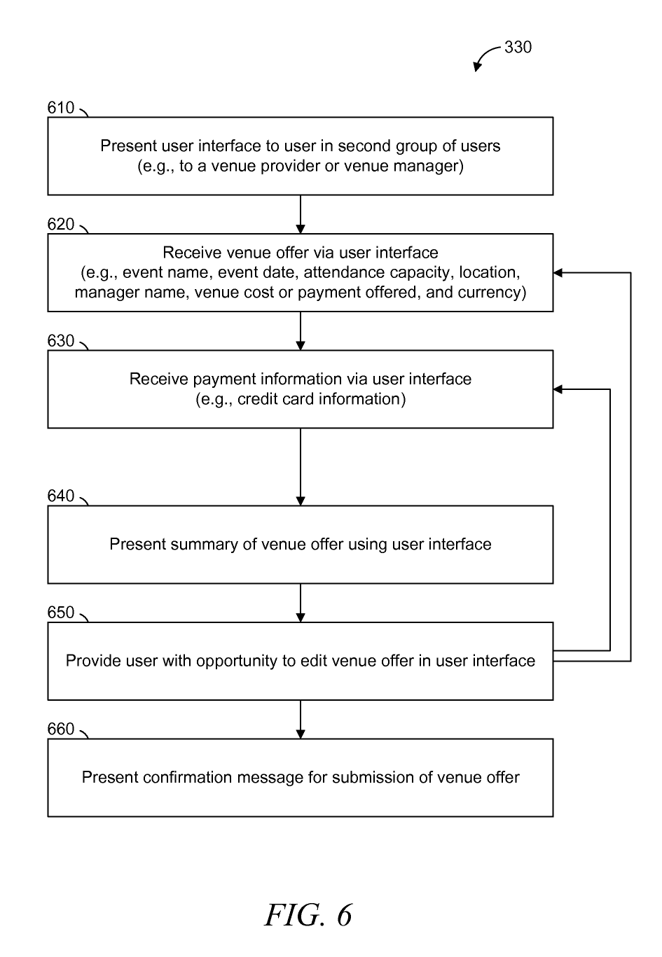

FIG. 6 illustrates further details of operation 330, in which the communication module 210 receives the venue offers from the venue providers (e.g., the second group of users of the user interface generated in operation 310). As shown, operation 330 may include one or more of operations 610, 620, 630, 640, 650, and 660.

In operation 610, the communication module 210 presents the user interface (e.g., as generated in operation 310) to a user of the user interface (e.g., to a venue manager of a venue available to host the event). In some example embodiments, the user is presented with a private portion of the user interface (e.g., accessible only to the user, for example, by submitting a username and password).

In operation 620, the communication module 210 receives a venue offer via the user interface (e.g., generated in operation 310). The venue offer may be submitted by the user to whom the user interface is presented in operation 610. According to various example embodiments, the venue offer may specify (e.g., by inclusion or reference) a name of the event (e.g., an event name), a date of event (e.g., an event date), an attendance capacity of the venue (e.g., a maximum attendance capacity), a location of the venue (e.g., an address, city, country, or any suitable combination thereof), a name of the corresponding venue provider (e.g., venue manager), a cost of the venue (e.g., venue cost), a payment offered by the venue (e.g., to the talent), a currency (e.g., U.S. dollars or Euros), or any suitable combination thereof.

In operation 630, the communication module 210 receives payment information that corresponds to the venue offer received in operation 620. The payment information may enable the venue to receive a payment (e.g., for the cost of the venue), make a payment (e.g., the payment offered by the venue), or both. Examples of such payment information include credit card number, bank account number, or other information suitable for initiating a payment transaction or an authorization thereof. The payment information may be received by the user interface (e.g., generated in operation 310), and the payment information may correspond to the user that submitted the venue offer.

In operation 640, the communication module 210 presents (e.g., via the user interface generated in operation 310) a summary of the venue offer received in operation 620. The summary of the venue offer may include some or all of the payment information received in operation 630.

In operation 650, the communication module 210 provides the user with an opportunity to edit some or all of the information presented in the summary of the venue offer. For example, the communication module 210 may present (e.g., via the user interface generated in operation 310) a confirmation screen or dialog box that prompts the user to confirm or edit the venue offer (e.g., as summarized in operation 640). As shown in FIG. 6, one or more of operations 620, 630, 640, and 650 may be repeated (e.g., until the user is finished submitting or editing the venue offer, the payment information, or any suitable combination or portion thereof).

In operation 660, the communication module 210 presents the user with a confirmation message (e.g., via the user interface generated in operation 310, or via email or text message) that the user's venue offer has been submitted. According to various example embodiments, operations 610-660 may be repeated for each venue provider (e.g., venue manager) of venues available to host the event (e.g., as proposed by the user interface generated in operation 310).

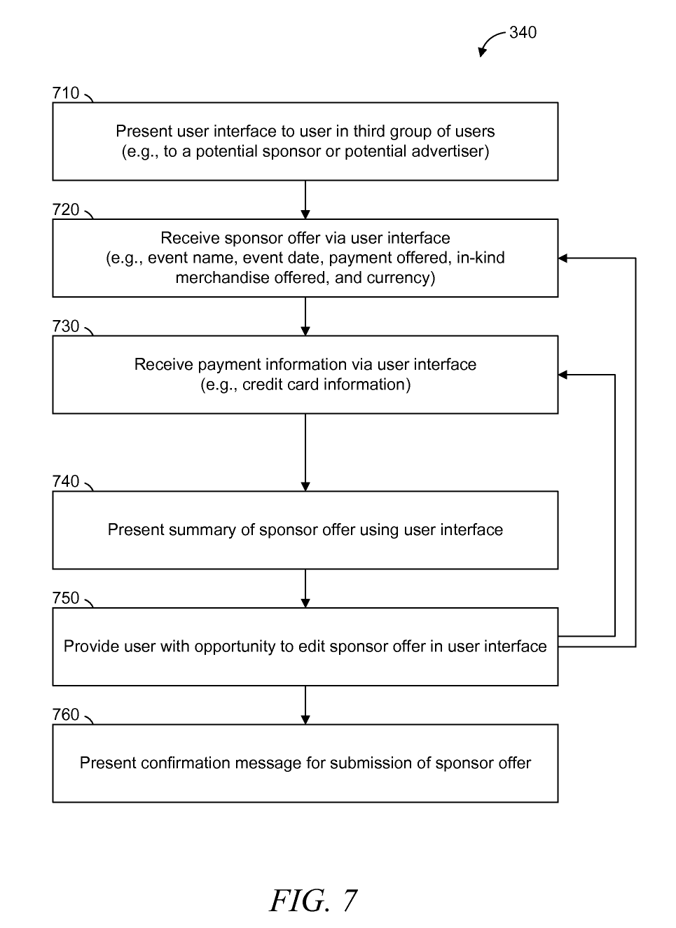

FIG. 7 illustrates further details of operation 340, in which the communication module 210 receives the sponsor offers from the potential sponsors (e.g., the third group of users of the user interface generated in operation 310). As shown, operation 340 may include one or more of operations 710, 720, 730, 740, 750, and 760.

In operation 710, the communication module 210 presents the user interface (e.g., as generated in operation 310) to a user of the user interface (e.g., to a potential sponsor available to sponsor the event). In some example embodiments, the user is presented with a private portion of the user interface (e.g., accessible only to the user, for example, by submitting a username and password).

In operation 720, the communication module 210 receives a sponsor offer via the user interface (e.g., generated in operation 310). The sponsor offer may be submitted by the user to whom the user interface is presented in operation 710. According to various example embodiments, the sponsor offer may specify (e.g., by inclusion or reference) a name of the event (e.g., an event name), a date of event (e.g., an event date), a payment offered by the sponsor (e.g., to the talent), a description of merchandise offered by the sponsor (e.g., an “in-kind” offer of merchandise to the talent, to the attendees of the event, or to both), a currency (e.g., U.S. dollars or Euros), or any suitable combination thereof.

In operation 730, the communication module 210 receives payment information that corresponds to the venue offer received in operation 720. The payment information may enable the sponsor to make a payment (e.g., the payment offered by the sponsor to the talent). Examples of such payment information include credit card number, bank account number, or other information suitable for initiating a payment transaction or an authorization thereof. The payment information may be received by the user interface (e.g., generated in operation 310), and the payment information may correspond to the user that submitted the sponsor offer.

In operation 740, the communication module 210 presents (e.g., via the user interface generated in operation 310) a summary of the sponsor offer received in operation 720. The summary of the venue offer may include some or all of the payment information received in operation 730.

In operation 750, the communication module 210 provides the user with an opportunity to edit some or all of the information presented in the summary of the sponsor offer. For example, the communication module 210 may present (e.g., via the user interface generated in operation 310) a confirmation screen or dialog box that prompts the user to confirm or edit the venue offer (e.g., as summarized in operation 740). As shown in FIG. 7, one or more of operations 720, 730, 740, and 750 may be repeated (e.g., until the user is finished submitting or editing the venue offer, the payment information, or any suitable combination or portion thereof).

In operation 760, the communication module 210 presents the user with a confirmation message (e.g., via the user interface generated in operation 310, or via email or text message) that the user's venue offer has been submitted. According to various example embodiments, operations 710-760 may be repeated for each potential sponsor (e.g., potential or prospective advertiser or merchandiser) available to sponsor the event (e.g., as proposed by the user interface generated in operation 310), in whole or in part.

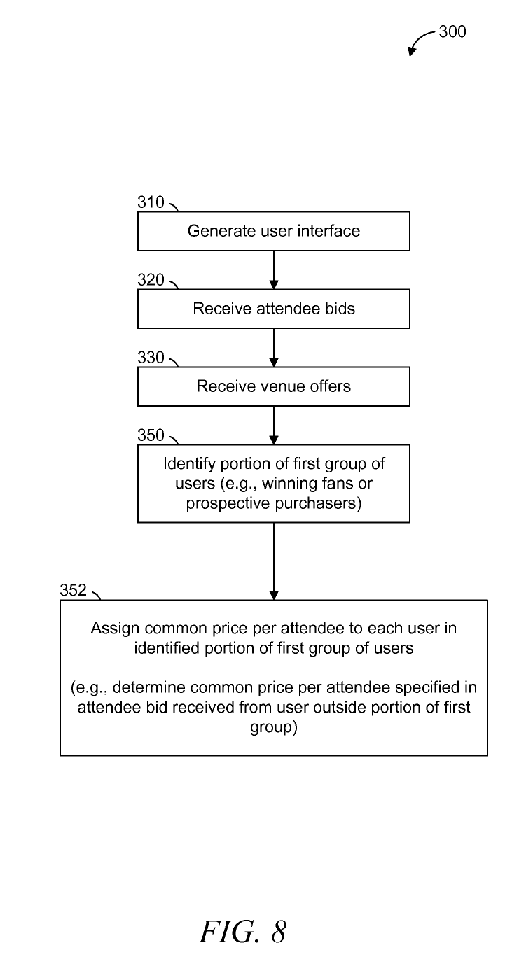

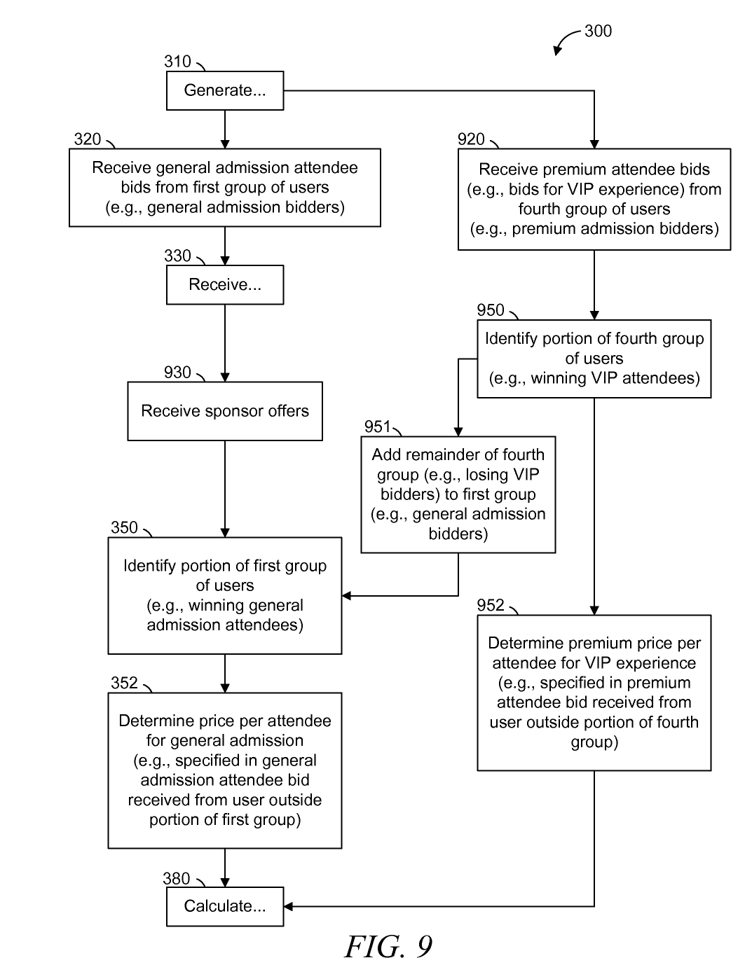

As shown in FIG. 8, some example embodiments of the method 300 include operations 310, 320, 330, 350, and 352, which are described above with respect to FIG. 3-6. As shown in FIG. 9, some example embodiments of the method 300 include operations 310, 320, 330, 350, 302, and 380, which are described above with respect to FIG. 3-6, as well as one or more of operations 920, 950, 951, and 952. In such example embodiments, multiple types of attendee bids supported by the event management machine 110 (e.g., general admission attendee bids and premium “VIP” attendee bids). Accordingly, in such example embodiments, operation 320 may be performed (e.g., by the communication module 210) by receiving general attendee bids (e.g., bids for general admission tickets or seats) from the potential purchasers. Similarly, operations 350 and 352 may be performed with respect to general attendee bids.

Operation 920 may be performed in a manner similar to that described above for operation 320. In operation 920, the communication module 210 receives premium attendee bids (e.g., a group or plurality of bids for premium or “VIP” tickets or seats) via the user interface generated in operation 310. The premium attendee bids may be received from prospective purchasers (e.g., affluent or devoted fans of the talent) of tickets for the event, and these prospective purchasers may constitute a fourth group of users (e.g., viewers) of the user interface. At least some of the premium attendee bids may differ in price per attendee to attend a premium (e.g., enhanced, exclusive, or otherwise special) experience at the event. That is, the received premium attendee bids may be diverse in their respective prices per attendee for the premium experience.

Operation 950 may be performed in a manner similar to that described above for operation 350. In operation 950, the decision module 220 identifies a portion of the prospective purchasers from the premium attendee bids that were received in operation 920. In particular, the decision module 220 may identify the portion of the prospective purchasers as winning premium bidders (e.g., who will purchase premium tickets to attend the event as VIP attendees of the event, if the event is scheduled). Operation 950 may be performed based on a VIP attendee capacity of a venue (e.g., the maximum attendee capacity for premium experiences at the venue, or a lesser attendee capacity for premium experiences, as specified by the talent). Operation 950 may be performed based on a portion of the premium attendee bids (e.g., submitted by the portion of the prospective VIP purchasers) specifying higher prices per attendee (e.g., higher VIP ticket prices) then the remainder of the premium attendee bids (e.g., submitted by the remainder of the prospective VIP purchasers). In some example embodiments, operation 950 may be performed based on the VIP attendee capacity and the portion of the premium attendee bids specifying higher prices per attendee than the remainder of the premium attendee bids.

In some example embodiments, operation 951 may be performed to merge non-winning (e.g., losing) prospective VIP purchasers with the potential purchasers of general admission tickets. In operation 951, where a portion of the prospective purchasers are identified in operation 950, the decision module 220 adds the remainder of the prospective purchasers to the above-discussed potential purchasers. The decision module 220 may treat some or all of their corresponding non-winning premium attendee bids as general attendee bids. In certain example embodiments, some or all of the corresponding non-winning premium attendee bids are discarded, and the decision module 220 may prompt some or all of the remainder of the prospective purchasers to submit general attendee bids (e.g., as discussed above with respect to FIG. 5).

Operation 952 may be performed in a manner similar to that described above for operation 352. In operation 952, the price module 230 assigns a common (e.g., shared) premium price per attendee (e.g., a single VIP price per attendee that is shared in common) to each prospective purchaser in the portion of the prospective purchasers identified in operation 950 (e.g., to each winning VIP bidder who will purchase VIP tickets to the event, if the event is scheduled). That is, all of the winning VIP bidders may be assigned a single VIP price per attendee (e.g., price per ticket or price per seat) that is shared in common by the winning VIP bidders. In some example embodiments, the common premium price per attendee may be specified in one of the premium attendee bids received in operation 920. In certain example embodiments, the common premium price per attendee may be specified in a premium attendee bid that is received from a prospective purchaser outside of the identified portion of the prospective purchasers (e.g., received from a non-winning VIP bidder). For example, the price module 230 may assign the premium price per attendee specified in the highest non-winning attendee bid as the common premium price per attendee for all of the winning VIP bidders. As another example, the second-highest non-winning premium attendee bid may specify the premium price per attendee used as the common premium price per attendee for all winning VIP bidders. In alternative example embodiments, the common premium price per attendee may be specified in a premium attendee bid that is received from a prospective purchaser within the identified portion of the prospective purchasers (e.g., received from a winning VIP bidder). For example, the price module 230 may assign the premium price per attendee specified in the lowest winning premium attendee bid as the common premium price per attendee for all of the winning VIP bidders.

In example embodiments that include operation 952, operation 380 may be performed (e.g., by the talent module 250) based on the common (e.g., shared) premium price per attendee (e.g., as assigned in operation 952). Accordingly, the talent module 250 may calculate the total fee earnable by the talent for attendance at the event, and the calculation of the total fee may be based on the common premium price per attendee.

According to various example embodiments, one or more of the methodologies described herein may facilitate determination of a price. Moreover, one or more of the methodologies described herein may facilitate identification of a portion of bidders as winning bidders able to purchase items (e.g., tickets for an event) at the determined price. Furthermore, one or more the methodologies described herein may facilitate proposal and scheduling of an event. Hence, one or more the methodologies described herein may facilitate efficient and convenient event management, with proposal and selection of prices to attend the event, the venue to host the event, and one or more sponsors to sponsor the event.

When these effects are considered in aggregate, one or more of the methodologies described herein may obviate a need for certain efforts or resources that otherwise would be involved in price determination, event management, or any suitable combination thereof. Efforts expended by one or more users in placing attendee bids to purchase tickets for an event, placing venue bids to host an event, placing sponsor bids to sponsor an event, or any suitable combination thereof, may be reduced by one or more of the methodologies described herein. Computing resources used by one or more machines, databases, or devices (e.g., within the network environment 100) may similarly be reduced. Examples of such computing resources include processor cycles, network traffic, memory usage, data storage capacity, power consumption, and cooling capacity.

FIG. 10 is a block diagram illustrating components of a machine 1000, according to some example embodiments, able to read instructions from a machine-readable medium (e.g., a machine-readable storage medium, a computer-readable storage medium, or any suitable combination thereof) and perform any one or more of the methodologies discussed herein, in whole or in part. Specifically, FIG. 10 shows a diagrammatic representation of the machine 1000 in the example form of a computer system and within which instructions 1024 (e.g., software, a program, an application, an applet, an app, or other executable code) for causing the machine 1000 to perform any one or more of the methodologies discussed herein may be executed, in whole or in part. In alternative embodiments, the machine 1000 operates as a standalone device or may be connected (e.g., networked) to other machines. In a networked deployment, the machine 1000 may operate in the capacity of a server machine or a client machine in a server-client network environment, or as a peer machine in a distributed (e.g., peer-to-peer) network environment. The machine 1000 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 1024, sequentially or otherwise, that specify actions to be taken by that machine. Further, while only a single machine is illustrated, the term “machine” shall also be taken to include a collection of machines that individually or jointly execute the instructions 1024 to perform all or part of any one or more of the methodologies discussed herein.

The machine 1000 includes a processor 1002 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1004, and a static memory 1006, which are configured to communicate with each other via a bus 1008. The machine 1000 may further include a graphics display 1010 (e.g., a plasma display panel (PDP), a light emitting diode (LED) display, a liquid crystal display (LCD), a projector, or a cathode ray tube (CRT)). The machine 1000 may also include an alphanumeric input device 1012 (e.g., a keyboard), a cursor control device 1014 (e.g., a mouse, a touchpad, a trackball, a joystick, a motion sensor, or other pointing instrument), a storage unit 1016, a signal generation device 1018 (e.g., a speaker), and a network interface device 1020.

The storage unit 1016 includes a machine-readable medium 1022 on which is stored the instructions 1024 embodying any one or more of the methodologies or functions described herein. The instructions 1024 may also reside, completely or at least partially, within the main memory 1004, within the processor 1002 (e.g., within the processor's cache memory), or both, during execution thereof by the machine 1000. Accordingly, the main memory 1004 and the processor 1002 may be considered as machine-readable media. The instructions 1024 may be transmitted or received over a network 1026 (e.g., network 190) via the network interface device 1020.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1022 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions for execution by a machine (e.g., machine 1000), such that the instructions, when executed by one or more processors of the machine (e.g., processor 1002), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

1. A method comprising:
generating a user interface that proposes an event and solicits a plurality of attendee bids and a plurality of venue offers;
receiving, via the user interface, the attendee bids from potential purchasers, at least some of the attendee bids differing in price per attendee of the event;
receiving, via the user interface, the venue offers from venue providers,
each venue offer specifying a corresponding venue able to hold an attendee capacity;
identifying a portion of the potential purchasers based on the attendee capacity and based on a portion of the attendee bids specifying higher prices per attendee than a remainder of the attendee bids; and
assigning, using at least one processor, a common price per attendee to each of the portion of the potential purchasers,
the assigned common price per attendee being specified in an attendee bid received from a potential purchaser outside the portion of the potential purchasers.

2. The method of claim 1 further comprising:
providing tickets to the portion of the potential purchasers at a cost based on the assigned common price per attendee specified in the attendee bid received from the potential purchaser outside the portion of the potential purchasers.

3. The method of claim 1, wherein:
the event includes an appearance by talent; and the method further comprises
calculating a total fee earnable by the talent for the appearance based on the attendee capacity and the common price per attendee.

4. The method of claim 3 further comprising:
communicating the total fee to the talent; and
scheduling the event based on reception of an indication that the talent has agreed to appear at the event.

5. The method of claim 3, wherein:
a venue offer among the venue offers includes a venue cost of the venue; and
the calculating of the total fee earnable by the talent is based on the venue cost.

6. The method of claim 3, wherein:
a venue offer among the venue offers includes a payment offered by the venue to the talent; and
the calculating of the total fee earnable by the talent is based on the payment offered by the venue to the talent.

7. The method of claim 3 further comprising:
communicating the venue offers to the talent; and
scheduling the event at the venue based on reception of an indication that the talent has selected the venue.

8. The method of claim 1 further comprising:
requesting authorizations to charge payments to the portion of the potential purchasers based on the assigned common price per attendee specified in the attendee bid received from the potential purchaser outside the portion of the potential purchasers.

9. The method of claim 8 further comprising:
receiving a subset of the authorizations to charge the payments; and
modifying the portion of the potential purchasers based on the received subset of the authorizations.

10. The method of claim 9, wherein:
initiating charges to the modified portion of the potential purchasers based on the assigned common price per attendee.

11. The method of claim 1, wherein:
the attendee bids from the potential purchasers are general attendee bids; and the method further comprises
receiving, via the user interface, a plurality of premium attendee bids from prospective purchasers;
identifying a portion of the prospective purchasers based on a portion of the premium bids specifying higher prices per attendee than a remainder of the premium attendee bids; and
assigning a shared price per attendee to each of the portion of the prospective purchasers,
the shared price per attendee being specified in a premium attendee bid from a prospective purchaser outside of the portion of the prospective purchasers.

12. The method of claim 11, wherein:
the event includes an appearance by talent; and the method further comprises
calculating a total fee earnable by the talent for the appearance based on the shared price per attendee.

13. The method of claim 1, wherein:
the event includes an appearance by talent; and the method further comprises
receiving, via the user interface, sponsor offers from potential sponsors,
each sponsor offer specifying a corresponding potential sponsor for the event; and
communicating the sponsor offers to the talent; and
receiving an indication that the talent has selected a sponsor among the potential sponsors.

14. The method of claim 13, wherein:
the sponsor offer includes a payment offered by the sponsor to the talent; and the method further comprises
calculating a total fee earnable by the talent based on the payment offered to the talent by the sponsor.

15. The method of claim 14, wherein:
communicating the total fee to the talent; and
scheduling the event based on the indication that the talent has selected the sponsor.

16. A non-transitory machine-readable storage medium comprising instructions that, when executed by one or more processors of a machine, cause the machine to perform operations comprising:
generating a user interface that proposes an event and solicits a plurality of attendee bids and a plurality of venue offers;
receiving, via the user interface, the attendee bids from potential purchasers, at least some of the attendee bids differing in price per attendee of the event;
receiving, via the user interface, the venue offers from venue providers,
each venue offer specifying a corresponding venue able to hold an attendee capacity;
identifying a portion of the potential purchasers based on the attendee capacity and based on a portion of the attendee bids specifying higher prices per attendee than a remainder of the attendee bids; and
assigning, using at least one processor, a common price per attendee to each of the portion of the potential purchasers,
the assigned common price per attendee being specified in an attendee bid received from a potential purchaser outside the portion of the potential purchasers.

17. The non-transitory machine-readable storage medium of claim 16, wherein:
the event includes an appearance by talent; and the operations further comprise
calculating a total fee earnable by the talent for the appearance based on the attendee capacity and the common price per attendee.

18. A system comprising:
a communication module configured to:
generate a user interface that proposes an event and solicits a plurality of attendee bids and a plurality of venue offers;
receive, via the user interface, the attendee bids from potential purchasers,
at least some of the attendee bids differing in price per attendee of the event; and
receive, via the user interface, the venue offers from venue providers,
each venue offer specifying a corresponding venue able to hold an attendee capacity;
a decision module configured to identify a portion of the potential purchasers based on the attendee capacity and based on a portion of the attendee bids specifying higher prices per attendee than a remainder of the attendee bids; and
a processor configured by a price module to assign a common price per attendee to each of the portion of the potential purchasers,
the assigned common price per attendee being specified in an attendee bid received from a potential purchaser outside the portion of the potential purchasers.

19. The system of claim 18, wherein:
the event includes a appearance by talent; and the system further comprises
a talent module configured to calculate a total fee earnable by the talent for the appearance based on the attendee capacity and the common price per attendee.

20. The system of claim 18, wherein:
the talent module is configured to communicate the total fee to the talent; and the system further comprises
a event module configured to schedule the event based on reception of an indication that the talent has agreed to appear at the event.
